(19) United States
(12) Patent Application Publication
(10) Pub. No.: US 2013/0143455 A1
(43) Pub. Date: Jun. 6, 2013

(54) Detectable Warning Mat made from Recycled Tire Rubber incorporating a Mesh Reinforcement

(71) Applicants: Ryan PETERSON, Riverside, CA (US); Richard Posiviata, Riverside, CA (US); Marlin Coulter, Riverside, CA (US)

(72) Inventors: Ryan PETERSON, Riverside, CA (US); Richard Posiviata, Riverside, CA (US); Marlin Coulter, Riverside, CA (US)

(21) Appl. No.: 13/310,933

(22) Filed: Dec. 5, 2011

(51) Int. Cl. B32B 3/24

(52) U.S. Cl. 442/1

(57) ABSTRACT

Improvements in a warning mat are with a mesh reinforcement disclosed. The improvements include using recycled tire rubber allows for use of a material that is not used in a landfill and the warning mat. The tires are chopped into fine pellets or strips, metal belting material is usually removed and the rubber is combined with a binding agent to recombine the rubber elements while still leaving some air spaces that improve the cushioning effect of the warning mat. A mesh reinforcement of typically expanded metal is sandwiched into the rubber particles to bond through the openings of the expanded metal whereby encapsulating the mesh reinforcement within the warning mat. The mesh reinforcement is extremely dimensionally stable and maintains the dimensions of the warning mat. Fairly large sections of warning mat can be fabricated for transportation and installation.

### CROSS REFERENCE TO RELATED APPLICATION

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates to improvements in a warning mat. More particularly, the present warning mat is made from recycled tire rubber and incorporates a mesh reinforcement that provides dimensional stability to the warning mat to prevent thermal expansion and contraction based upon the weather.

2. Description of Related Art including information disclosed under 37 CFR 1.97 and 1.98

Warning mats are used in a variety of locations within and around play fields and sporting fields where a person can “feel” a difference in the ground as they progress off of one surface and onto the warning mat. This feature is highly desirable for a baseball player as they keep their eyes on a ball and move off of grass and onto the warning mat or track prior to reaching a wall. The warning mat can extend over 100 yards as it wraps around the outer edge of a stadium.

Detectable Warning Mats are used to alert drivers, pedestrians and others of dangers. When driven over, the bumps or ridges on the mat produce a loud and unmistakable noise alerting a driver to some issue, such as an intersection, toll gate, etc. The Mats are affixed to roadways, parking lots, concrete foundations or driveways, etc. within areas where visual and audible warnings are desired, such as the approach to a stop sign. They are used to alert the visually impaired of intersections and in train stations where stops are made. Typically, bolts and inserts are affixed to the Mat, which is then placed in wet concrete. When the concrete sets up, the inserts will remain in place and the mat can be replaced if needed by simply removing the bolts or screws, removing the old Mat and securing a new Mat in place. Any number of fastening and adhering means exist.

Mats have primarily been molded from various plastics and polymers. To date, no one has been able to produce a viable product made primarily from recycled tire rubber. The Invention herein described is a formulation and method of producing a Detectable Warning Mat made from recycled tire rubber that meets industry requirements. In other words, the Mat's coefficient of expansion matches that of concrete closely such that there is no undesirable deformation of the Mat over time when it is in its desired position. Deformation that causes buckling, flared edges, etc. can be a tripping hazard and will result in decreased product lifetime.

Thermal expansion of un-reinforced rubber is multiplied over the expansion of warning mat resulting gaps and cracks. Several products and patents have been used to make warning mats or surfaces. Exemplary examples of patents covering these products are disclosed herein.

U.S. Pat. No. 5,827,009 issued on Oct. 27, 1998 to Basil George Kokoletsos discloses a tactile warning surface, method and apparatus. The warning surface is fabricated by pressing a mold sheet into a composite material in a semi-liquid state. The composite material then cures and hardens leaving the tactile elements. This patent does not include the inclusion of reinforcement to maintain dimensional stability. It relies upon a bond with an underlying substrate. Once the bond with the substrate is compromised the entire surface can shift, curl and lift.

U.S. Pat No. 6,951,435 issued Oct. 4, 2005 to Paul Michael Fennessy Sr. discloses a method and apparatus for forming new and retrofits detectable warning surfaces. The warning surface in this patent is made in manually portable sections where each section can be individually set, removed and or replaced. The individual pieces are not reinforced and can shrink and expand to create cracks and buckling.

U.S. Pat. No. 7,001,103 issued on Feb. 21, 2006 discloses a device for producing tactile-detectable warning surface and method for employing same. This patent discloses stamps of warning surfaces that are secured together. The stamps are separately molded to for raised areas and air cushions. This patent does not include reinforcement and is molded as opposed to being formed from recycled tire rubber.

Finished product, regardless of whether or not it is attached to concrete, does not deform and, as will be discussed below, one of the components of the overall mixture does not migrate to the surface. This migration of that component, namely Chopped Strands of Fiberglass, to the surface is problematic in that it is not desirable to allow the free release of minute fiberglass particles into the local environment, and over time the product will break down and fail to meet the guidelines for which it was designed.

What is needed is a warning mat that is fabricated from recycled tire rubber. The warning mat should further incorporate a mesh reinforcement that makes the warning mat retain dimensional stability from thermal expansion and contraction.

### BRIEF SUMMARY OF THE INVENTION

Initial discussions relating to the warning mat took place in early 2010. After research some trial and error testing began in March, 2011. In about Mar. 29, 2011, a process and formulation produced the desired results. Methods and variations continue to fine-tune the overall process and formulations. The current preferred embodiment is described herein.

It is an object of the warning mat to provide warning to the visually impaired that the surface where they are walking has changed to allow them to take appropriate action. The action taken can be a variable based upon the circumstances. In general the notification is that the person is approaching an area where their safety is in jeopardy. The raised and lowered areas should generally not prevent egress over the warning pad but should be sufficient to be detectable under foot.

It is another object of the warning mat to be made from recycled tire rubber. The use of recycled tire rubber allows for use of a material that is not used in a landfill and the warning mat is an ideal use for tires that have exceeded their useful life. The tires are chopped into fine pellets or strips, metal belting material is usually removed and the rubber is combined with a binding agent to recombine the rubber elements while still leaving some air spaces that improve the cushioning effect of the warning mat.

It is still another object of the warning mat to be fabricated with mesh reinforcement. The mesh reinforcement is typically expanded metal that allows rubber particles to bond through the openings of the expanded metal whereby encapsulating the mesh reinforcement within the warning mat. The mesh reinforcement is extremely dimensionally stable and maintains the dimensions of the warning mat. Fairly large sections of warning mat can be fabricated for transportation and installation.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a top perspective view of the warning mat.

FIG. 2 shows an exploded top perspective view of the warning mat.

FIG. 3 shows a cross sectional view of the warning mat with a single mesh placed in the middle of the warning mat.

FIG. 4 shows a perspective view of the mesh reinforcement with a two mesh products placed in the bottom and upper portion of the warning mat.

FIG. 5 shows a perspective view of the mesh reinforcement

### DETAILED DESCRIPTION OF THE INVENTION

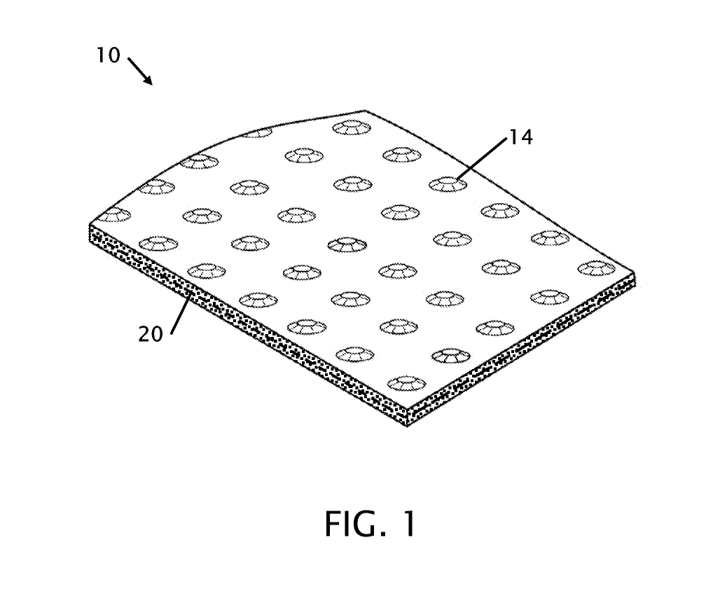

FIG. 1 shows a top perspective view of the warning mat 10. The basic molding process is compression molding within a heated mold. This preferred method of making the warning mat has been adapted to this process by controlling the heat, cycle time, molding pressure, etc., for making the warning mat. Various other methods and process are contemplated, the special formulation and mold filling process that is a key part fabrication of the warning mat 10 with made from recycled tires incorporating mesh reinforcement 20.

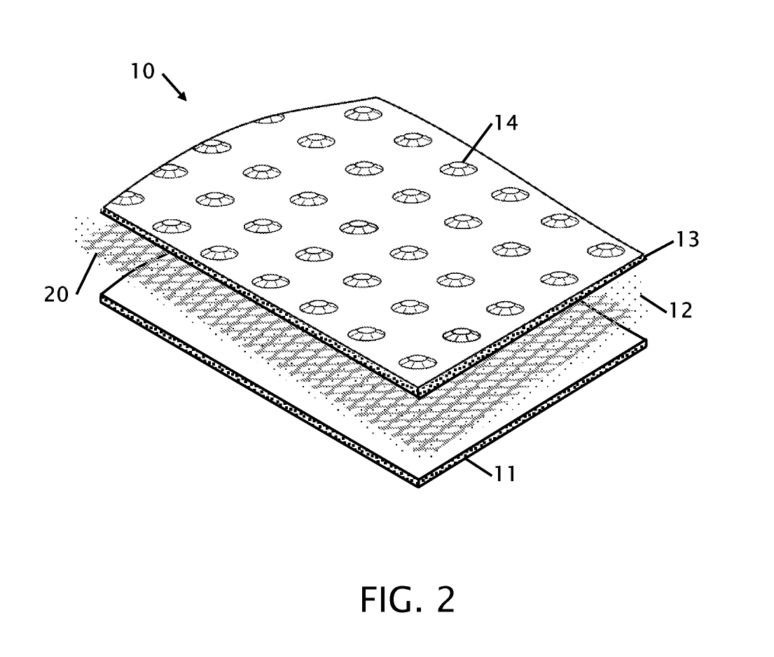

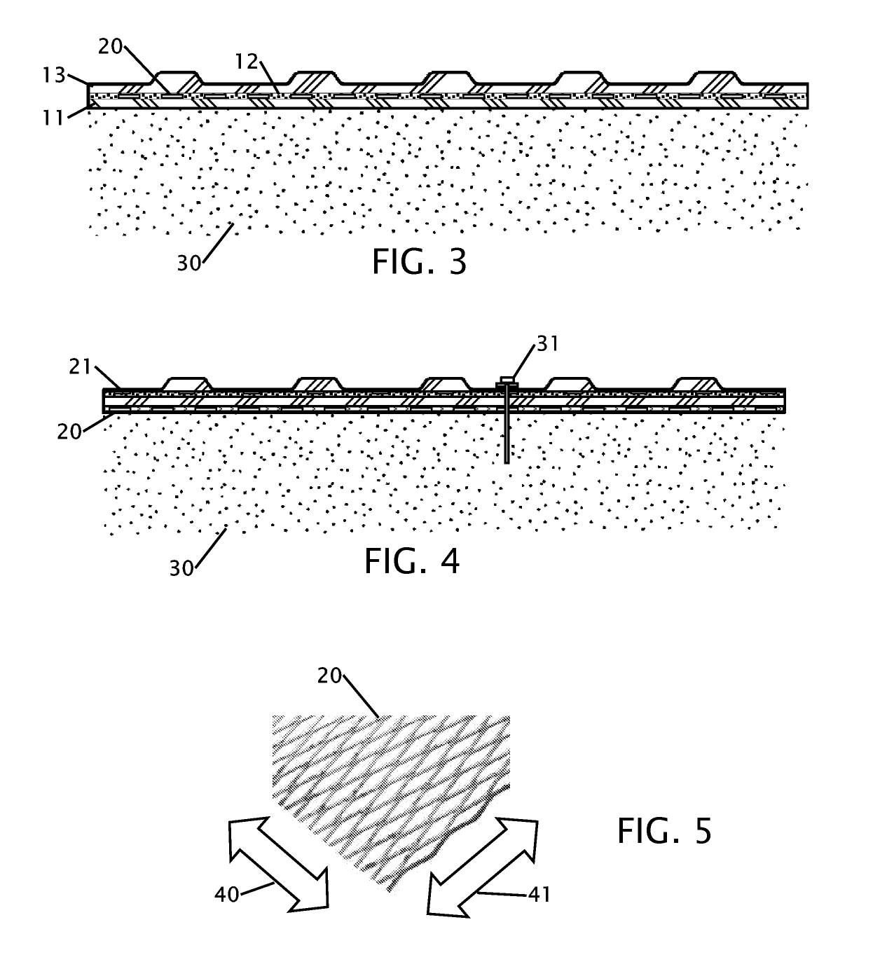

FIG. 2 shows an exploded top perspective view of the warning mat 10 and FIG. 3 shows a cross sectional view of the warning mat 10. In fabrication of the warning mat, a base layer 11 consisting of a mixture of fine particles of crumb rubber (recycled tire rubber), typically 20 mesh, and a 2-part binder, #6180700, is put in place in the mold cavity. This is followed by a center layer 12 consisting of a mixture of specially coated fiberglass particles (Chopped Strands, Coated, #DS5102-13C, %′), 20 mesh (typical) crumb rubber and the 2-part binder #6180700. Then, a final (third) layer 13 is added on top of the center layer 12, this layer 12 consisting of the same mixture as the first 11, or base, layer. While recycled tire rubber of 20 mesh is preferred, a mesh in a range of between 10 and 40 provides equivalent performance, but other mesh as small as 200 to as large as ¼″ is contemplated. The final third layer has topographical features such as domes 14 that provide a tactile feel when a person walks, drives or otherwise maneuvers over the warning mat 10.

FIG. 3 shows a perspective view of the mesh reinforcement with a single mesh placed in the middle of the warning mat. This document adds one important step to the above process. Either just before adding the center layer or just after adding it, a mesh reinforcement is positioned in the mold, such that after the mold is filled and the molding cycle completed, the mesh is sandwiched as a ‘layer’ within the finished product. This mesh 20 can be made out of anything desired; polymer, metal, alloy, fiberglass, etc. In the preferred embodiment the mesh reinforcement is expanded metal. The reinforcement material can be other materials from flexible to rigid based upon the desired finished product. It is also contemplated that the mesh can be placed at the bottom of the mold, or the top of the mold if one would like the mesh to be visible. The mesh 20 could be colored, of any mesh size, and could actually contain text or logos such that, when the finished product is viewed, the text, image, etc. is visible.

One can further incorporate more than 1 mesh layer 20 or mesh material in the finished product, one in the center and on top. FIG. 4 shows a perspective view of the mesh reinforcement with a two mesh products placed in the bottom 20 and upper 21 portion of the warning mat. If more than one mesh product is used the two mesh products can be different materials with different flexibility, rigidity, and or mesh ratio.

In both FIGS. 3 and 4 the warning mat is shows installed on a base 30 that is usually asphalt or concrete where the warning mat can be bonded with gluing or screwed 31 or bolted into the base 30.

The top layer provides the desired overall appearance and durability. The precise formulation and method(s) of filling the mold are proprietary and are considered as a preferred embodiment, as is the overall process and specific list of ‘ingredients’, to be Trade Secrets.

FIG. 5 shows a perspective view of the mesh reinforcement. Mesh material that is made from expanded metal is formed by piercing a metal sheet and pulling the sheet to form the open mesh. Because the sheet is pulled open, thermal expansion and bending strength can differ depending upon placement of the expansion direction 40 or 41 installing the warning mat with mesh in a particular dimension can provide expansion in one direction 40 and little or no expansion in the perpendicular direction 41.

The document discloses the concept and the various processes and procedures required to create the final product, which can be made in any number of contemplated configurations and variations, based upon the desired end use, mold design, etc. The molding process could include compression and or heat as required to create the finished molded component. The product could be made via various molding processes or via an extrusion or conveyor-like process, etc. Any number of color options or other fabrication and design feature options are likewise available.

Thus, specific embodiments of a detectable warning mat made from recycled tire rubber incorporating mesh reinforcement have been disclosed. It should be apparent, however, to those skilled in the art that many more modifications besides those described are possible without departing from the inventive concepts herein. The inventive subject matter, therefore, is not to be restricted except in the spirit of the appended claims.

1. A detectable warning mat made from recycled tire rubber incorporating a mesh reinforcement comprising:
a base layer comprising of a mixture of fine particles of crumb rubber and a 2-part binder, #6180700,
a center layer comprising of a mixture of coated fiberglass coated with #DS5102-13C, and the 2-part binder #6180700;
at least a third layer added on top of said center layer wherein said third layer comprising of a mixture of fine particles of crumb rubber and a 2-part binder, #6180700, and
mesh reinforcement is positioned essentially within said center layer such that said mesh reinforcement is sandwiched within said warning mat.

2. The detectable warning mat according to claim 1 wherein said particles of crumb rubber of said base layer is recycled tire rubber of between 10 and 40 mesh.

3. The detectable warning mat according to claim 2 claim 1 wherein said particles of crumb rubber of said base layer is recycled tire rubber of 20 mesh.

4. The detectable warning mat according to claim 1 wherein fiberglass is particles of chopped fiberglass strands,

5. The detectable warning mat according to claim 1 wherein said particles of crumb rubber of said at least a third layer is recycled tire rubber of between 10 and 40 mesh.

6. The detectable warning mat according to claim 5 claim 1 wherein said particles of crumb rubber of said at least a third layer is recycled tire rubber of 20 mesh.

7. The detectable warning mat according to claim 1 wherein said mesh reinforcement is selected from a group consisting of polymer, metal, alloy and fiberglass.

8. The detectable warning mat according to claim 1 wherein said mesh reinforcement is expanded metal.

9. The detectable warning mat according to claim 1 that further includes placing said base layer, said center layer, said at least a third layer and said mesh reinforcement in a mold cavity and applying pressure and heat to bond said mesh reinforcement with said base layer, said center layer, said at least a third layer.

10. The detectable warning mat according to claim 1 that wherein said warning mat is formed in an extrusion.

11. The detectable warning mat according to claim 1 that wherein said warning mat is formed in a conveyer process.

12. A detectable warning mat made from recycled tire rubber incorporating a mesh reinforcement comprising:
a base layer comprising of a mixture of fine particles of crumb rubber and a 2-part binder, #6180700,
a second layer on top of said base layer comprising of a mixture of coated fiberglass coated with #DS5102-13C, and the 2-part binder #6180700 with a first mesh reinforcement positioned essentially within said second layer;
a third layer on top of said second layer comprising of a mixture of fine particles of crumb rubber and a 2-part binder, #6180700;
a fourth layer on top of third layer is said mixture of coated fiberglass coated with #DS5102-13C, and the 2-part binder #6180700 with a second mesh reinforcement positioned essentially within said fourth layer, and
a top of comprising of a mixture of fine particles of crumb rubber and a 2-part binder, #6180700.

13. The detectable warning mat according to claim 12 wherein said particles of crumb rubber of said base layer is recycled tire rubber of between 10 and 40 mesh.

14. The detectable warning mat according to claim 12 wherein fiberglass is particles of chopped fiberglass strands,

15. The detectable warning mat according to claim 12 wherein said particles of crumb rubber of said at least a third layer is recycled tire rubber of between 10 and 40 mesh.

16. The detectable warning mat according to claim 12 wherein said particles of crumb rubber of said top layer is recycled tire rubber of between 10 and 40 mesh.

17. The detectable warning mat according to claim 12 wherein said first mesh reinforcement is selected from a group consisting of polymer, metal, alloy and fiberglass.

18. The detectable warning mat according to claim 12 wherein said second mesh reinforcement is selected from a group consisting of polymer, metal, alloy and fiberglass.

19. The detectable warning mat according to claim 12 wherein said first mesh reinforcement or said second mesh reinforcement is expanded metal.

20. The detectable warning mat according to claim 12 that further includes placing said base layer, said center layer, said third layer, said fourth layer and said top layer in a mold cavity and applying pressure and heat to bond said mesh reinforcement with said base layer, said center layer, said third layer, said fourth layer and said top layer.
